(19) United States
(12) Patent Application Publication
(10) Pub. No.: US 2010/0313128 A1
(43) Pub. Date: Dec. 9, 2010

(54) SYSTEM AND METHOD FOR FREE FORM COMMENTS FOR A PROGRAMMABLE LOGIC CONTROLLER

(75) Inventors: Scotty R. Phillips, Jonesborough, TN (US); Thilo Opaterny, Nurnberg (DE); Lothar Pfahlmann, Bairersdorf (DE); Stephan Schaer, Nurnberg (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Energy & Automation, Inc., Alpharetta, GA (US)

(21) Appl. No.: 12/477,455

(22) Filed: Jun. 3, 2009

(51) Int. Cl. G06F 3/048; G06F 9/45

(52) U.S. Cl. 715/715; 717/137; 715/766; 715/765; 715/768

(57) ABSTRACT

A method of annotating a specification of a programmable logic controller is provided that includes displaying a graphical element in a first graphical language for programming the programmable logic controller, and displaying a comment associated with the graphical element. A method for converting a specification for a programmable logic controller in a first language to a second language is provided that includes converting a first instruction in the first language to a second instruction in the second language, and converting a first comment associated with the first instruction to a second comment associated with the second instruction. A computer-readable recording medium is provided.

### CROSS REFERENCE TO RELATED APPLICATIONS

This application claims the benefit of U.S. Provisional Application No. 61/056,500, filed May 28, 2008, the disclosure of which is herein incorporated by reference.

### FIELD OF THE INVENTION

The present invention relates to programming programmable logic controllers (PLCs), and in particular relates to programming PLCs using different languages with comments.

### BACKGROUND OF THE INVENTION

A PLC is a solid-state, microprocessor based, real-time computing system that may be used, via a network, to automatically monitor the status of field-connected sensor inputs, and automatically control devices of a controlled industrial system (e.g., actuators, solenoids, relays, switches, motor starters, speed drives (e.g., variable frequency drives, silicon-controlled rectifiers, etc.), pilot lights, igniters, tape drives, speakers, printers, monitors, displays, etc.). A PLC may operate according to a user-created set of values and user-created logic and/or instructions stored in memory. The sensor inputs may reflect measurements and/or status information related to the controlled industrial system.

A PLC can replace thousands of relays and cam timers due to its precise and real-time timing and sequencing capabilities. PLC hardware often has good redundancy and fail-over capabilities. A PLC may use a Human-Machine Interface (HMI) for interacting with users for configuration, alarm reporting, and/or control.

Programmable controllers in general, and PLCs in particular, can execute program code in a repetitive process referred to as a scan. A scan can start with the CPU reading a status of inputs. The application program can be executed using the status of inputs. Once the program is complete, the CPU can perform internal diagnostics and/or communication tasks. The scan cycle can end by updating the outputs, then start over. The cycle time can depend on the size of the program, the number of I/O's, and/or the amount of communication required.

A PLC may be programmed using ladder logic or some form of structured programming language, for instance as specified in IEC 61131-3, namely, LD (Ladder Diagram), FBD (Function Block Diagram), ST (Structured Text), IL (Instruction List), SFC (Sequential Function Chart). LAD and FBD are graphic-oriented programming languages, and STL is a text-oriented programming language. Each of these programming languages can be used in STEP 7, which is programming software that can be used to program PLCs, such as the SIEMENS SIMATIC S7-300 and SIMATIC S7-400. Generally, SIMATIC is an automation system that can be used for implementing industrial control systems, such as for machines, manufacturing plants, and/or industrial processes.

LAD may use graphical symbols that resemble electromechanical elements used in a relay logic diagram format to describe hard-wired control. The left vertical line of a typical Ladder Logic Diagram may represent a power or energized conductor. A right vertical line may represent a return path of a hard-wired control line diagram, and may be omitted. Ladder Logic Diagrams may read from left to right, and from top to bottom. Rungs may be referred to as networks, and a network may have several input and output instructions. Input instructions may be represented by a series of contacts, in one or more parallel branches. Input instructions may perform comparisons and/or tests, and may be normally left justified on the rung. Output instructions may be represented by coils, for which there may only be one in each output branch. Output instructions may execute some operations and/or functions, and/or may be right justified on the rung.

To write programming instructions, generate configuration data, and/or download the code and configuration data to a programmable controller, several tools can be used. A programming device, such as a soft real-time device, for instance a personal computer (PC), can be interfaced with a PLC. Typically, a proprietary cable, such as SIEMENS PCIPPI, may connect a PCs RS 232 port with the PLC. Engineering software tools, such as SIEMENS STEP 7, may be installed on the PC so that the PC can be used to write programming instructions for the PLC.

### SUMMARY OF THE INVENTION

A method of annotating a specification of a programmable logic controller is provided that includes displaying a graphical element in a first graphical language for programming the programmable logic controller, and displaying a comment associated with the graphical element.

In the method, the graphical element represents at least one of an input, an output, an operation, an operand, a function, an instruction, a comparison, a test, a wire, a network, a branch, a rung, and a code. The comment explains at least one of an identity, a purpose, a task, an activity, a status, data, and an arrangement of the graphical element. The comment may be arranged in a bubble attached by an anchor line to the graphical element.

The method may also include displaying a second comment with one of the graphical element and a second graphical element. The second comment may be in a second bubble attached by a second anchor line to the one of the graphical element and the second graphical element.

A method for converting a specification for a programmable logic controller in a first language to a second language is provided that includes converting a first instruction in the first language to a second instruction in the second language, and converting a first comment associated with the first instruction to a second comment associated with the second instruction.

The converting of the first comment to the second comment may include identifying a graphic equivalent of the first instruction and displaying a bubble for the second comment. The bubble may be visually associated with the graphic equivalent.

The converting of the first comment to the second comment may include identifying a text equivalent of the first instruction and displaying the second comment on a line immediately following the text equivalent.

A computer-readable recording medium is provided having recorded thereon an executable program. The program when executed causes a processor to perform any of the methods described herein.

### BRIEF DESCRIPTION OF THE DRAWINGS

FIG. 1 illustrates a graphical instruction for a programmable logic controller.

FIG. 2 illustrates the graphical instruction of FIG. 1 with a pop-up menu including an “insert comment” command.

FIG. 3 illustrates the graphical instruction of FIG. 1 with a comment box attached.

FIG. 4 illustrates the graphical instruction of FIG. 1 and the comment box of FIG. 3 with another pop-up menu.

FIG. 5 illustrates a comment box having a resizable function.

FIG. 6 illustrates an effect of resizing a comment box on the comment.

FIG. 7 illustrates the graphical instruction of FIG. 1 with two comments boxes overlapping.

FIG. 8 illustrates a translation of the graphical instruction of FIG. 7 into another graphical language with revised comment boxes.

FIG. 9 illustrates a translation of the graphical instructions of FIGS. 7 and 8 into a text-based language including revised comments.

FIG. 10 is a flow chart illustrating a method according to an exemplary embodiment of the instant invention.

FIG. 11 is a block diagram of a computer in accordance with an embodiment of the present invention.

### DETAIL DESCRIPTION

When writing instructions in a graphic-oriented PLC programming language, it may be beneficial to add comments (also referred to herein as annotations) to those instructions to, for example, explain the identity, location, purpose, task, activity, status, data, and/or arrangement, etc., of any one or more elements of the instructions, such as one or more inputs, outputs, operations, operands, functions, instructions, comparisons, tests, wires, networks, branches, rungs, and/or code, etc.

Certain exemplary embodiments of the instant invention allow a user to enter free form comments (that is, essentially any text desired by the user) in graphic-oriented PLC programming languages, such as LAD and/or FBD, directed to a specific element of the program. The comment can be attached to any element of the diagram, such as an instruction, operand, and/or wire. In certain exemplary embodiments, the user can specify and/or adjust the properties and/or format (e.g., font, style, size, color, effects, spacing, and/or transparency, etc.) of the text of the comment as desired.

The user may edit a comment simply by, for example, single-clicking within the comment “box” and/or by right-clicking on the attached element and selecting “Edit Comment” from a pop-up contextual menu. While in edit mode, the comment can be edited. Moving and resizing may occur when the comment is not being edited.

One or more potentially user-adjustable and/or configurable “anchor lines” (e.g., one or more curves and/or line segments) can attach a comment to its associated element(s). A comment's location can default to a particular location, such as to the right and/or below the element to which it is attached. In certain exemplary embodiments, a comment may be connected to an element, detached from an element, re-attached to an element, and/or attached to one or more new elements.

After a comment has been added, it may be adapted to receive input from a user. This can allow the user to immediately begin inputting the text of the comment without additional user actions.

The user may position the comment anywhere within the network and/or adjust the size of the comment as needed and/or desired. For example, the user may move the comment by, for example, clicking on its border. The user may resize the comment by, for example, clicking on one of its handles. When a comment is moved and/or resized, its anchor line may be automatically re-oriented and/or re-routed as needed to maintain the anchor line's connection to the element(s).

In certain exemplary embodiments, properties such as the text formatting, shape, text set-off, background color, border color, and/or border thickness, etc., of the default and/or a specific comment box and/or anchor line can be user-defined and/or adjustable.

A comment box can be automatically re-sized to accommodate added text. Since the size of the comment box can be user-adjustable, it can be possible for only part of its text to be visible. If the comment is resized, the text of a comment can be restructured and/or reformatted to fit within the resized box. If the entire text of the comment is not visible, then an ellipsis can be appended and/or displayed as a visual indication of the hidden text.

Because comments can overlap, the Z order (also referred to as a virtual depth in a screen image) and/or position of a comment can configurable. By using, for example, the comment's contextual menu, the user can, for example, bring a comment associated with an Add instruction forward and/or to the front, and/or send a comment associated with a coil backwards and/or to the back.

A comment can be positioned anywhere within an image of the graphical instructions. The transparency of the comment can be adjustable. For example, via a comment's contextual menu, a user can adjust the transparency of the comment.

When the user converts from one programming language to another, the comments can be automatically mapped and/or converted to the new language. For example, when switching between LAD and FBD, comments can be converted directly to a corresponding instruction. When switching languages, the positions of the comments can be automatically adjusted as needed. Any unattached comments can be positioned at a default location, such as at the top or bottom of the network.

As another example, when converting from a graphic-oriented PLC programming language, such as LAD or FBD, to a text-oriented PLC programming language, such as STL, the free form comments may become line comments, which may be located beside the corresponding instruction. For example, in the case of an ADD _I instruction, four STL instructions can be provided. The comment may be mapped to and/or associated with the instruction that most closely represents the original instruction.

When moving from a graphical language to a text-based language, the main AWL instruction may receive the box comment. The comments on wires may be put to L and T instructions (also referred to herein as load and transfer instructions). In a conversion from a text-based language to a graphical language, L and T line comments may be put on wires, and a main instruction may be put to the box. Comments on an ENO (enable output) handling instructions may be merged to the box.

In certain exemplary embodiments, to the extent permitted by the programming language into which the comment is converted, properties of the comment box, anchor line, and/or comment text (e.g., font, style, size, color, effects, spacing, and/or transparency, etc.) can be preserved during the conversion.

In certain exemplary embodiments, via one or more user interfaces, such as a graphical user interface, a user can view a rendering of information related to specifying, editing, revising, converting, compiling, executing, implementing, outputting, and/or communicating a programming instruction and/or comment.

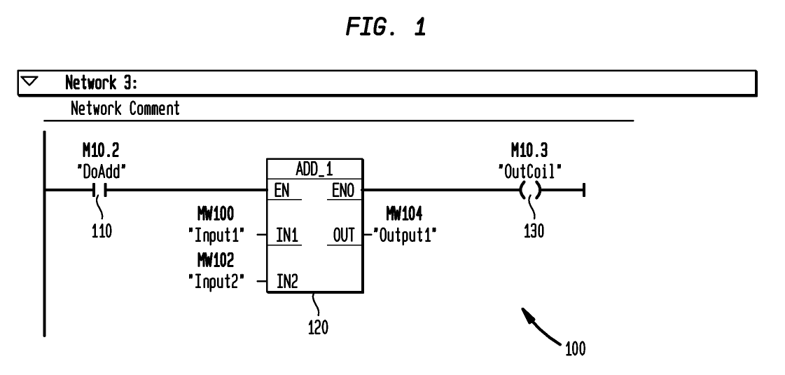

Specification 100 of FIG. 1 represents a set of graphical instructions (also referred to herein as graphical elements) of a graphical language for programming a programmable logic controller. Element 110 of FIG. 1 is a “DoAdd” which is input into element 120. The inputs can be switches, pushbuttons, and/or contact closures. Element 120 of FIG. 1 represents an add function. One output of element 120 is an enable output (ENO) which is output to element 130. Element 130 represents an “OutCoil”. The output could be, for example, a solenoid and/or a light bulb.

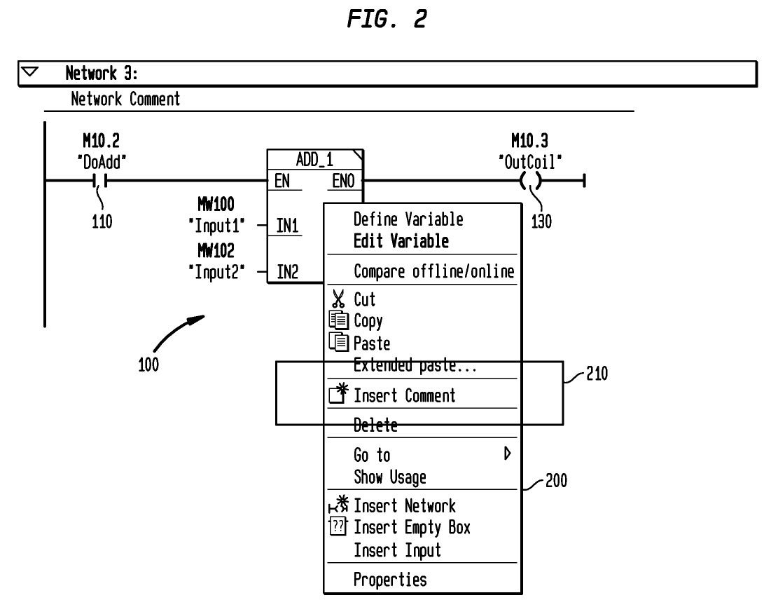

FIG. 2 illustrates specification 100 of FIG. 1 with an additional pop-up menu that may be obtained while editing the specification 100 by selecting element 120. Element 120 may be selected to provide pop-up menu 200 by right clicking a mouse, double clicking a mouse, or by any other appropriate method. Pop-up menu 200 includes various commands for editing specification 100, including command 210. Command 210 provides a command to “insert comment”.

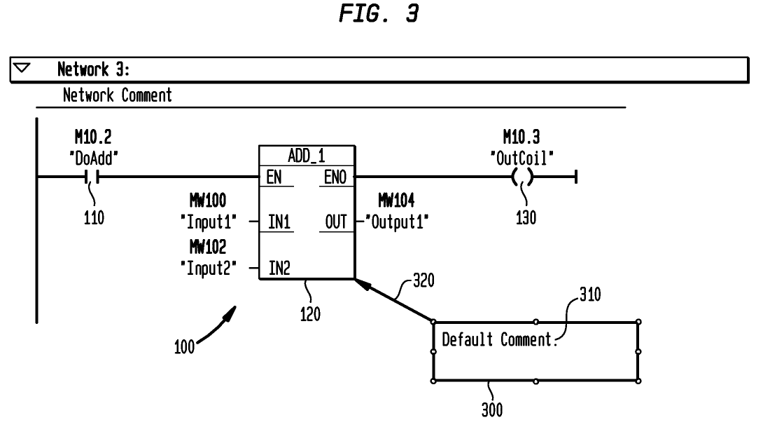

FIG. 3 illustrates specification 100 including the graphical instruction of FIG. 1 with comment box 300 (also referred to herein as a bubble) attached. Comment box 300 may be provided after selecting command 210 as shown in FIG. 2. Comment box 300 includes comment 310, and is attached to element 120 by anchor line 320. A default position for comment box 300 may be a lower right hand corner of specification 100. Anchor line 320 may default to connect comment box 300 to element 120. After creating comment box 300, comment 310 may be edited to include any type of information that may be useful to a programmer and/or a user of the program.

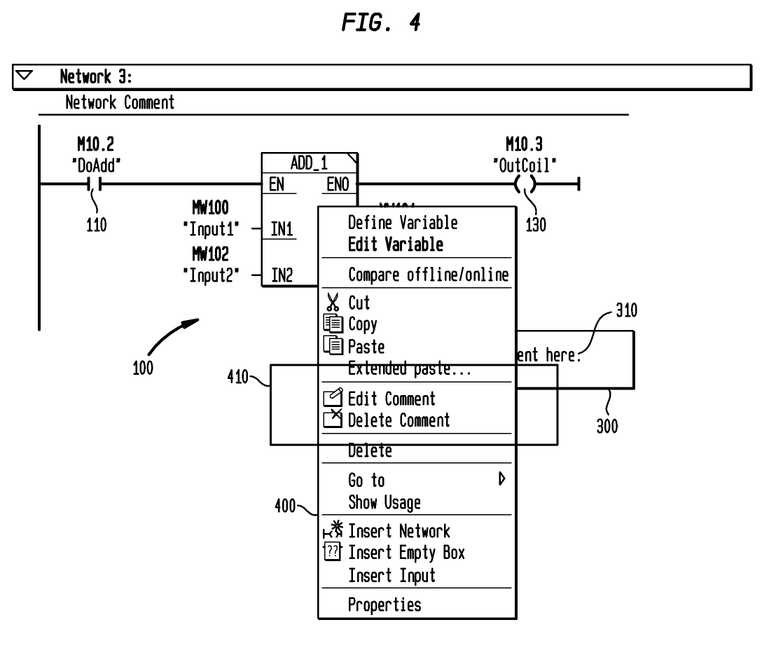

FIG. 4 illustrates the graphical instruction of FIG. 1 and the comment box of FIG. 3 with another pop-up menu 400 including an “edit comment” and “delete comment” instruction. Pop-up menu 400 may be used to edit a comment 310 or delete a comment box 300. Box 410 of FIG. 4 illustrates the edit comment and delete comments commands of pop-up menu 200.

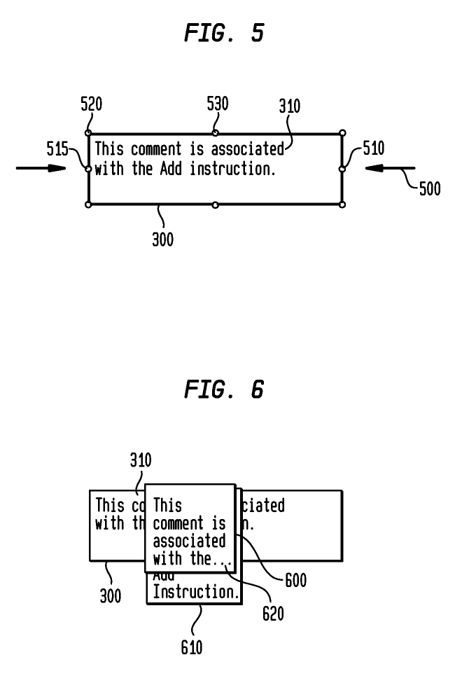

FIG. 5 illustrates a comment box having a resizable function for comment box 300. Comment box 300 including comment 310 may be narrowed in a direction 500 by selecting a handle 510 and moving it in a direction towards handle 515. Alternatively, a user may select handle 515 and move it towards handle 510. Additionally comment box 300 may be widened in the opposite manner, or the dimension of comment box 300 may be changed in two directions by selecting a corner handle 520. Likewise, the height of comment box 300 may be changed by selecting handle 530.

FIG. 6 illustrates a change in the size of comment box 300 including a narrow comment box 600 which is too small to show the entirety of comment 310 in the font size selected. Therefore narrow comment box 600 includes an ellipsis 620 which indicates that only part of comment 310 is shown. Tall comment box 610 is also shown in overlap fashion to comment box 300 and narrow comment box 600. Tall comment box 610 is large enough to include all of comment 310 without an ellipsis.

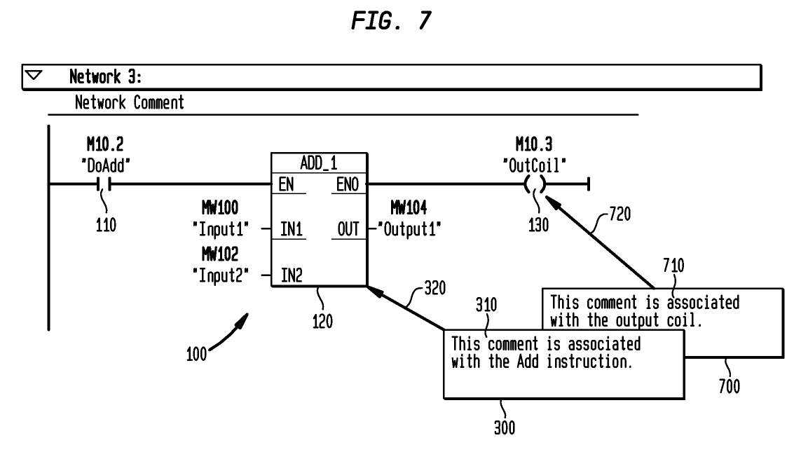

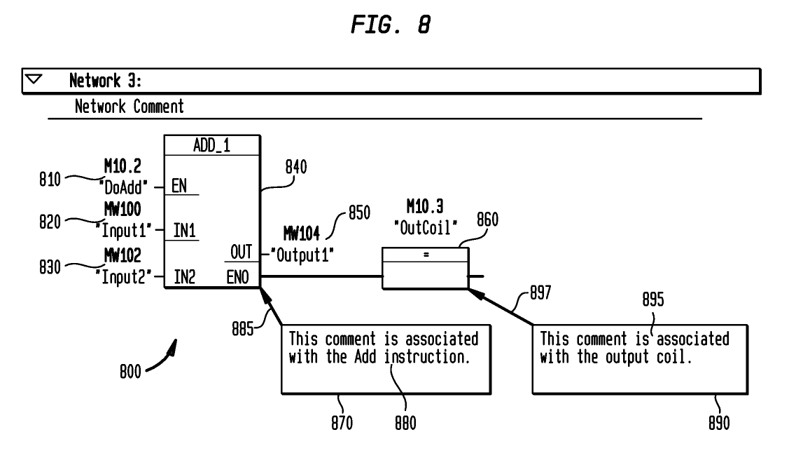

FIG. 7 illustrates multiple comment boxes for specification 100 shown in an overlapping fashion. Comment box 300 overlaps comment box 700. Comment box 700 includes comment 710 and is attached to element 130 by anchor line 720. Both comment box 300 and comment box 700 may be moved by selecting the respective comment box and dragging it to an appropriate location. When comment box 300 is moved, anchor line 320 is adjusted to continue to attach comment box 300 to element 120. Comment box 700 may also have the same movable qualities. An order of overlapping of comment box 300 and comment box 700 may be adjusted by selecting either box by right clicking a mouse or by any other appropriate method, and by selecting a command from a pop-up menu to “move to front”, “move to back”, “move forward”, “move backward”, or by any other appropriate method.

FIG. 8 shows the translation of the program of FIG. 1 from LAD into Function Block Diagrams (“FBDs”). In this example, each function has a name to designate its specific task, and each function is indicated by a rectangle. In this example, inputs are shown on the left-hand side of the rectangle and outputs are shown on the right-hand side. The exemplary Function Block Diagram of FIG. 8 may programs a PLC to perform the same tasks as the program of FIG. 1.

FIG. 8 illustrates a translation of specification 100 to specification 800. Specification 800 represents a same or similar functionality as specification 100 in a different graphical language for programming a programmable object controller. Element 110 of specification 100 is translated into element 810 of specification 800, which also indicates “DoAdd”. Specification 800 also shows inputs 820 and 830, as well as element 810 being input into instruction 840. Inputs 820 and 830 may correspond to inputs shown in FIG. 7 and labeled “IN1” and “IN2”. Instruction 840 is an add instruction which has an output 850 as well as an ENO. The ENO is output to element 860, which is an “OutCoil”. Comment box 870 including comment 880 attaches to instruction 840 by anchor line 885. Likewise, comment box 890 including comment 895 attaches to instruction 860 by anchor line 897. Comment box 890 includes the same comment as comment box 700 in FIG. 7. Comment box 890 attaches to the element of the graphical language which is comparable to element 130 shown in FIG. 7. Specifically comment 890 attaches to instruction 860, which includes the same output coil function as shown in the graphical language of specification 100 shown in FIG. 7. Likewise, comment 870 attaches to the same add instruction as comment 300 in FIG. 7. Specifically comment 870 attaches to instruction 840 which is a translation of instruction of specification 100 shown in FIG. 7.

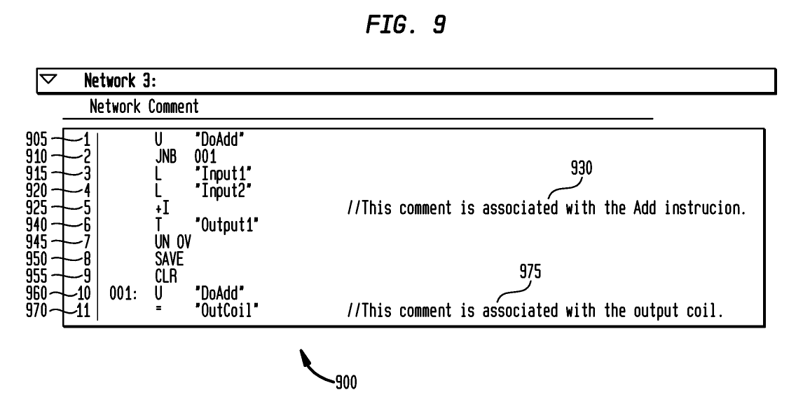

FIG. 9 illustrates a translation of the graphical instructions of FIGS. 7 and 8 into a text-based language including revised comments. An Instruction List (“IL”) or Statement List (“STL”) are examples of text-based instruction sets. In some text-based languages, the operation (i.e., what is to be done) is shown on the left, and the operand (i.e., the item to be operated on by the operation) is shown on the right. An LAD and an IL program can have a similar structure and a set of exemplary IL instructions can perform the same task as an LAD code.

Specification 900 is a translation of specification 100 into a text-based language. Element 905 includes a “DoAdd” instruction. Element 910 includes a JNB001. JNB is a jump instruction in which, if the result of the logical operation is 0, JNB interrupts the linear program scan and jumps to the designated label. In other words, if the “DoAdd” contact is “off” then the program jumps to the 001 label. The user may only want to perform the add operation when the contact is “on”, otherwise the logic is skipped.

Elements 915 and 920 of FIG. 9 are line inputs. Element 925 is an add instruction, which is followed on the same line by comment 930. Elements 940, 945, 950, 955, and 960 are other elements of specification 900 which have been translated from specification 100. Element 970 is an outcoil instruction that includes comment 975 on the same line following the instruction. Comment 930 follows on the same line as element 925. Likewise, comment 975 follows on the same line as element 970. Comment 930 includes the same comment as comment box 700 in FIG. 7 and comment box 870 in FIG. 8. Comment 930 attaches to the line instruction corresponding to the element of the graphical language that is comparable to element 120 shown in FIG. 7 or element 840 in FIG. 8. Specifically comment 930 attaches to element 925, which includes the same add instruction as elements 120 and 840 in FIGS. 7 and 8, respectively. Likewise, comment 975 follows on the same line as element 970 in FIG. 9. Element 970 is a translation of the instruction represented by element 130 of specification 100 shown in FIG. 7, or a translation of element 860 in FIG. 8. Element 970 and element 860 include the same output coil function of element 130 shown in specification 100 of FIG. 1.

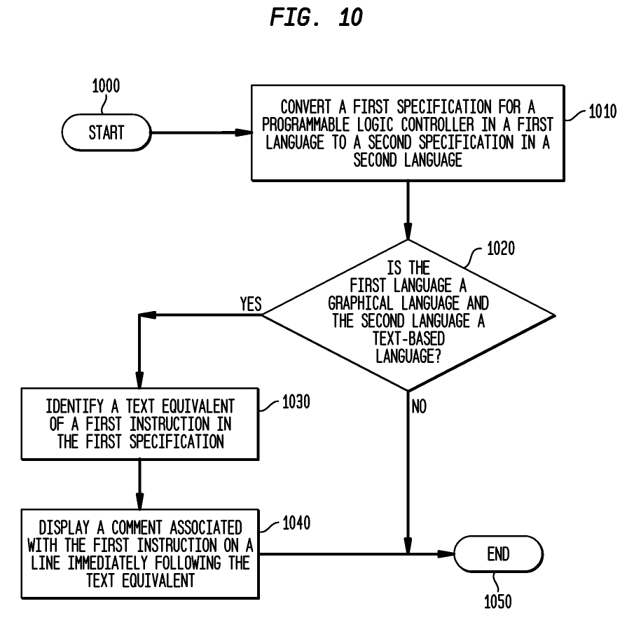

FIG. 10 is a flow chart illustrating a method according to an exemplary embodiment of the instant invention. The flow in FIG. 10 starts at Start 1000 and flows to operation 1010, which indicates to convert a first specification for a programmable logic controller in a first language to a second specification in a second language. From operation 1010, the method flows to decision 1020, which asks whether the first language is a graphical language and the second language is a text-based language. If the response to decision 1020 is affirmative, the method flows to operation 1030, which indicates to identify a text equivalent of a first instruction in the first specification. From operation 1030, the method flows to operation 1040, which indicates to display a comment associated with the first instruction on a line immediately following the text equivalent. From operation 1040, the method flows to End 1050. If the response to decision 1020 is negative, the method also flows to End 1050.

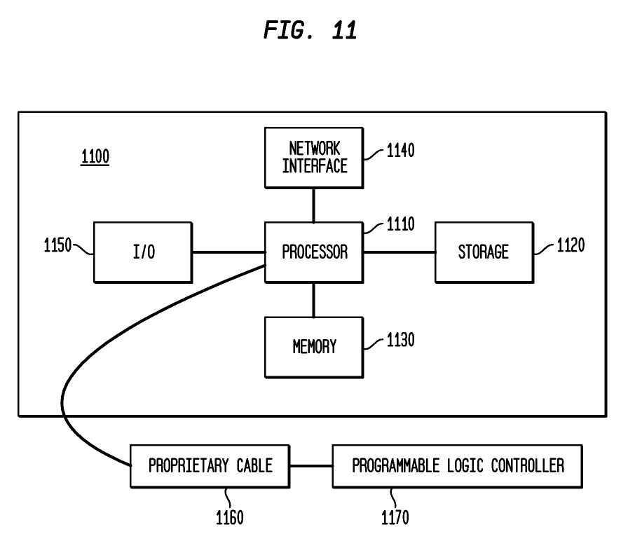

FIG. 11 is a high-level block diagram of a computer in accordance with an embodiment of the present invention. Computer 1100 can perform the steps described above (e.g., with respect to FIGS. 2 and 11). Computer 1100 may contain processor 1110 which controls the operation of the computer by executing computer program instructions which define such operation, and which may be stored on a computer-readable recording medium. The computer program instructions may be stored in storage 1120 (e.g., a magnetic disk, a database) and loaded into memory 1130 when execution of the computer program instructions is desired. Thus, the computer operation will be defined by computer program instructions stored in memory 1130 and/or storage 1120 and computer 1100 will be controlled by processor 1110 executing the computer program instructions. Computer 1100 also includes one or more network interfaces 1140 for communicating with other devices, for example other computers, servers, or websites. Network interface 1140 may, for example, be a local network, a wireless network, an intranet, or the Internet. Computer 1100 also includes input/output 1150, which represents devices which allow for user interaction with the computer 1100 (e.g., display, keyboard, mouse, speakers, buttons, webcams, etc.). Processor 1110 is coupled to proprietary cable 1160, which is coupled to PLC 1170. In this manner, a user of computer 1100 may be able to program PLC 1170 using any appropriate programming language. One skilled in the art will recognize that an implementation of an actual computer will contain other components as well, and that FIG. 10 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention.

We claim:

1. A method of annotating a specification of a programmable logic controller, comprising:
displaying a graphical element in a first graphical language for programming the programmable logic controller; and
displaying a comment associated with the graphical element.

2. The method of claim 1, wherein the graphical element represents at least one of an input, an output, an operation, an operand, a function, an instruction, a comparison, a test, a wire, a network, a branch, a rung, and a code.

3. The method of claim 1, wherein the comment explains at least one of an identity, a purpose, a task, an activity, a status, data, and an arrangement of the graphical element.

4. The method of claim 1, wherein the comment is arranged in a bubble attached by an anchor line to the graphical element.

5. The method of claim 4, wherein at least one of a size of the bubble and one of a font and a font size of the comment is adjustable.

6. The method of claim 4, further comprising displaying a second comment with one of the graphical element and a second graphical element, the second comment being in a second bubble attached by a second anchor line to the one of the graphical element and the second graphical element.

7. The method of claim 6, wherein the comment and the second comment overlap, an order of the first comment and the second comment being adjustable front to back.

8. The method of claim 1, wherein a transparency of the comment is adjustable.

9. A method for converting a specification for a programmable logic controller in a first language to a second language, comprising:
converting a first instruction in the first language to a second instruction in the second language; and
converting a first comment associated with the first instruction to a second comment associated with the second instruction.

10. The method of claim 9, further comprising associating the comment with the first instruction.

11. The method of claim 9, wherein one of the first and second languages is a graphical language.

12. The method of claim 11, wherein the comment is displayed in a bubble when the one of the first and second language is the graphical language.

13. The method of claim 9, wherein:
the first language is a text-based language and the second language is a graphical language; and
the converting of the first comment to the second comment includes identifying a graphic equivalent of the first instruction and displaying a bubble for the second comment, the bubble being visually associated with the graphic equivalent.

14. The method of claim 13, wherein:
when the first instruction is one of a load instruction and a transfer instruction, the bubble for the second comment is associated with a wire;
when the first instruction is a main instruction, the bubble for the second comment is associated with a box; and
when the first instruction is an ENO handling instruction, the bubble for the second comment is merged to the box.

15. The method of claim 9, wherein:
the first language is a graphical language and the second language is a text-based language; and
the converting of the first comment to the second comment includes identifying a text equivalent of the first instruction and displaying the second comment on a line immediately following the text equivalent.

16. The method of claim 15, wherein:
when the first instruction is a wire, the second comment is displayed proximate to one of a load instruction and a transfer instruction; and
when the first instruction is a box, the second comment is displayed proximate to a main instruction.

17. A computer-readable recording medium having recorded thereon an executable program, the program when executed causing a processor to perform a method, the method comprising:
displaying a graphical element in a first graphical language for programming the programmable logic controller; and
displaying a comment associated with the graphical element.

18. A computer-readable recording medium having recorded thereon an executable program, the program when executed causing a processor to perform a method, the method comprising:
converting a first instruction in the first language to a second instruction in the second language; and
converting a first comment associated with the first instruction to a second comment associated with the second instruction.
